(19) United States
(12) Patent Application Publication
(10) Pub. No.: US 2005/0045531 A1
(43) Pub. Date: Mar. 3, 2005

(54) Method for the manual merging of manually processable mail flats

(75) Inventors: Peter Bretschneider, Birkenwerder (DE); Wolf-Stephan Wilke, Konstanz (DE)

Correspondence Address: SIEMENS SCHWEIZ;I-44, INTELLECTUAL PROPERTY, ALBISRIEDERSTRASSE 245, ZURICH, CH-8047, CH

(73) Assignee: SIEMENS AKTIENGESELLSCHAFT, MUNICH (DE)

(21) Appl. No.: 10/925,009

(22) Filed: Aug. 25, 2004

Related U.S. Application Data
(60) Provisional application No. 60/499,613, filed on Sep. 3, 2003.

(30) Foreign Application Priority Data
Sep. 25, 2003 (DE) 10344576.5

(51) Int. Cl. B07C 5/00; G06K 9/00

(52) U.S. Cl. 209/584; 209/900

(57) ABSTRACT

The invention relates to a method for the manual merging of manually processable mail flats with mail items sorted automatically in a sorting machine according to a distribution sequence and deposited on a section conveyor, which transports the mail items in the sections to a collection station, at which the mail items are stacked automatically in collectors in the distribution sequence. The divider cards identifying delivery points, which are so large and stable that they form compartments between the mail items in the collector, are automatically inserted before or after the mail items for a delivery point or delivery point area. The collectors are only filled with mail items and divider cards to such a level that there is still space for the mail items to be merged manually. The collectors are then transported to the competent delivery office, where the manually processable mail items are inserted into the corresponding compartments according to their delivery address.

### CROSS REFERENCE TO RELATED APPLICATIONS

The present application claims priority to provisional application No. 60/499,613, filed on Sep. 3, 2003 and German application 10344576.5, filed Sep. 25, 2003, the both of which are herein incorporated by reference.

### BACKGROUND OF THE INVENTION

The invention relates to a method for the manual merging of manually processable mail flats with mail items sorted automatically in a sorting machine according to a distribution sequence and deposited on a section conveyor, which transports the mail items in the sections to a collection station, in which the mail items are automatically stacked in the distribution sequence in collectors.

With all hitherto known automation solutions however some of the mail items can still only be processed manually. They can therefore not be inserted by machine into the stacks of mail items. This is then done by the mail operative. This is essentially because of the format characteristics. If these mail items are not inserted into the bundle for each delivery point or at least at the correct point in the stack, the time saving that can be achieved during delivery is reduced, as in addition to the bundle stack, the mail operative also has to process a second stack of manual mail items.

In so far as manually processable mail items had to be merged with a stack of mail items sorted by machine in distribution sequence, the stack of mail items sorted by machine into distribution sequence was also frequently sorted again manually by the mail operative into the compartments into which manual mail items were also sorted. This process however requires a great deal of time and effort.

### SUMMARY OF THE INVENTION

The object of the invention is therefore to create a generic method for the manual merging of manually processable mail flats with mail items sorted automatically in a sorting machine according to the distribution sequence and transported by section conveyor to collectors, with which the necessary manual time and effort are reduced.

The divider cards identifying the delivery points, which are so large and stable that they form compartments between the mail items in the collector, are thereby merged automatically before or after the mail items for a delivery point or delivery point area. The collectors are only filled with mail items and divider cards to such an extent that there is still space for the mail items to be merged manually. The collectors are then transported to the competent delivery office, where the manually processable mail items are inserted into the corresponding compartments according to their delivery address.

It is therefore advantageous to transport the divider cards automatically to the sections assigned to the delivery points before the automatically sorted mail items are deposited. This can be effected for example using a device as disclosed in DE 198 29 484 C1 but without reading devices.

It is also possible to transport the divider cards automatically to the sections assigned to the delivery points after the automatically sorted mail items have been deposited.

It is also possible to transport the divider cards automatically between the corresponding mail items/stacks of mail items directly to the collectors during automatic loading of the collector from the section conveyor. So that the mail items do not slip out of place or get mixed up during transport, the space for the mail items to be merged manually is filled by a filler element to hold the mail items in place during transport to the mail operatives.

To configure the manual merging of mail items ergonomically, it is advantageous to design the collectors so that they can be stacked with the opening facing the side and be stacked to form a wall of compartments on a movable frame for the manual merging of the mail items.

So that the employees responsible for sorting can reach the openings in the collectors easily with the smallest possible change to their position, it is advantageous to configure part of the frame so that it can be pivoted about a vertical axis at the side where the collector openings are located.

It is also advantageous if the divider cards are colored to correspond to areas of the distribution route so that employees can find their way round the resulting wall of compartments more easily.

### BRIEF DESCRIPTION OF THE SEVERAL VIEWS OF THE DRAWINGS

The invention is described below using an exemplary embodiment with reference to the drawing, in which

FIG. 1 shows a schematic side view of a section conveyor with a collector, with which the divider cards are laid on the belt before the sorting machine,

FIG. 2 shows the top view of a filled collector,

FIG. 3 shows the side view of a movable frame with stacked collectors forming a wall of compartments.

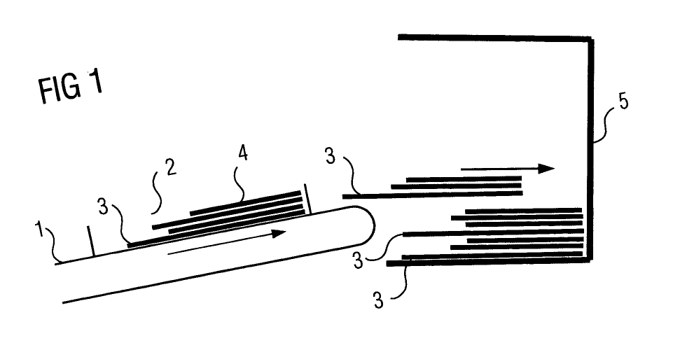

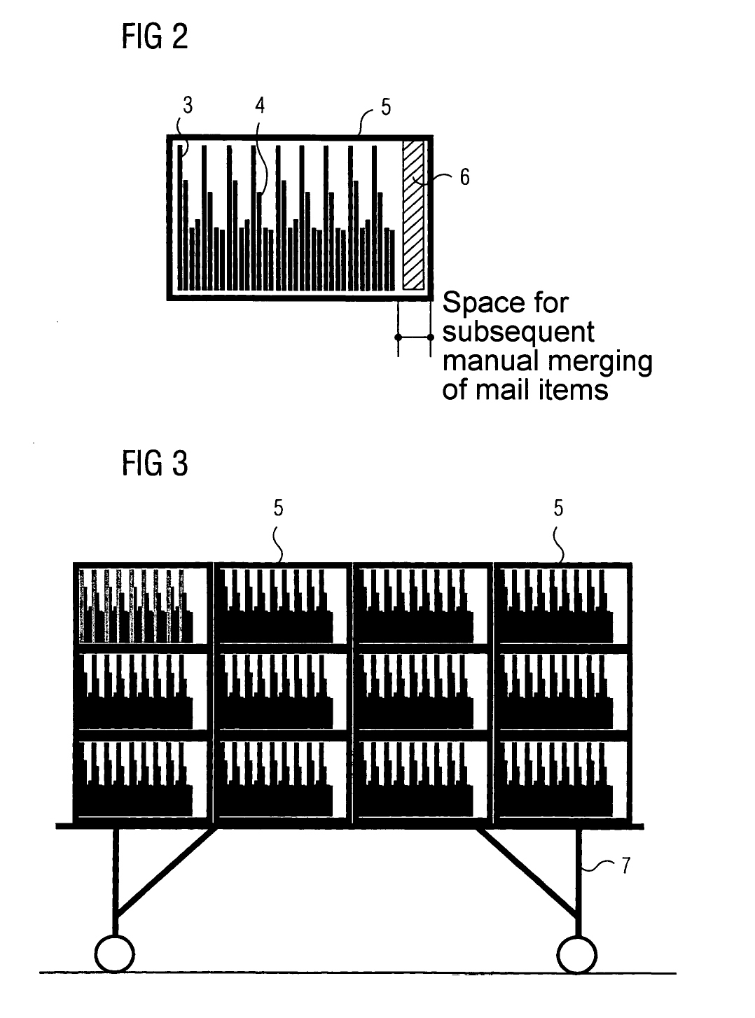

### DETAILED DESCRIPTION OF THE INVENTION

The inventive solution feed the mail items 4 sorted by machine with minimum transport volume to the mail operative or a person in the delivery office in a form which allows the manual merging of only manually processable mail items in an efficient and ergonomic manner.

For this purpose, divider cards 3 are automatically merged with the mail items 4 automatically loaded in the distribution sequence in sections 2 of a section conveyor 1 by means of a sorting machine.

This is achieved in that before the sorting machine the divider cards 3 are laid at the bottom of the sections using a device as disclosed in DE 198 29 484 C1 but without reading devices and buffer segments. If certain areas of the distribution route are to be identified by colored divider cards, a plurality of stacking receptacles with separating devices (one stacking receptacle for each color) as shown in DE 198 29 484 C1 is useds of course also possible to lie the divider cards 3 on top after the mail items 4 on the section conveyor 1. It would also be possible to insert the divider cards into the collector 5 in addition to the mail items 4 at the correct time in the collection station, as partitions between the mail items for the distribution stops. If required a divider card 3 may only be inserted after mail items for a plurality of delivery points. The divider cards 3 must thereby be tailored to the dimensions of the collector 5 and they must be rigid so that they form compartments in the collector 5, between which the sorted mail items 4 are located. The receptacle 5 is only filled to such a level before transport that there is still space for subsequent manual merging of only manually processable mail items. To ensure the position and orientation of the mail items during transport, the space is filled with a removable filler element 6. The collectors 5 are then transported to the delivery office whilst maintaining the distribution sequence. There they are stacked on movable frames 7 with the openings to the side, for example using robots, so that a wall of compartments is formed, into the compartments of which the competent employee inserts the mail items processed manually. For better identification of the compartments, the divider cards 3 can be colored or identified in some other way. The movable frame 7 can also be designed to fold so that the wall of compartments is L-shaped and can therefore be loaded with less movement.

After manual merging of the mail items and the completion of any control activities there are a number of possible ways to proceed further:
a) Stacks of mail items can be removed from the collectors 5 leaving behind the divider cards 3, bundled by the mail operative as required and thereby prepared for delivery. Large format mail items can then be inserted in the correct places in the stack,
b) Stacks of mail items are left in the collectors 5 with the divider cards 3. The collectors 5 are transported to the delivery vehicle and loaded there. Removal from the collectors 5 takes place during delivery,
c) as b), but the divider cards 3 are removed beforehand 3 (possible with “packaged” stacks of mail items).

1. A method for the merging manually processable mail flats with automatically sorted mail items in a sorting machine according to a distribution sequence and deposited on a section conveyor, which transports the mail items in the sections to a collection station at which the mail items are stacked automatically in the distribution sequence in collectors, comprising the steps of:
automatically merging divider cards identifying delivery points, the cards being, so large and stable that they form compartments in the collector between the mail items, before or after the mail items for a delivery point or delivery point area;
filling the collectors with the mail items and divider cards to such a level that there is still space for the mail items to be merged manually; and
transporting collectors to a competent delivery office where the manually processable mail items are inserted into the corresponding compartments according to their delivery address.

2. The method according to claim 1, wherein the divider cards are automatically transported in the sections assigned to the delivery points before the automatically sorted mail items are deposited.

3. The method according to claim 1, wherein the divider cards are automatically transported in the sections assigned to the delivery points after the automatically sorted mail items have been deposited.

4. The method according to claim 1, wherein the divider cards are transported by the section conveyor automatically between corresponding mail items or stacks of mail items directly to the collectors during automatic loading of the collector.

5. The method according to claim 1, wherein the space for the mail items to merge manually is filled by a filler element during transport to the delivery office to hold the mail items in place.

6. The method according to claim 1, wherein the collectors are configured so that they can be stacked with opening facing a side and are stacked to form a wall of compartments on a movable frame for manual merging of the mail items.

7. The method according to claim 6, wherein part of the frame can be pivoted about a vertical axis at a side where the openings of the collectors are located.

8. The method according to claim 1, wherein the divider cards are colored to correspond to areas of a distribution route.
